(19) United States
(12) Patent Application Publication
(10) Pub. No.: US 2012/0038172 A1
(43) Pub. Date: Feb. 16, 2012

(54) RENEWABLE POWER STORAGE UTILIZING LIQUID GAS

(76) Inventor: Ralph GREENBERG, Santa Rosa, CA (US)

(21) Appl. No.: 12/857,500

(22) Filed: Aug. 16, 2010

(51) Int. Cl. F03G 7/00; F28D 15/00

(52) U.S. Cl. 290/1 R; 165/104.11

(57) ABSTRACT

Machinery and methods for converting inexpensive electricity to higher value electricity. A system includes means for compressing a gas such as air, means for condensing the gas to a liquid stream, means for storing liquefied gas, means for pumping the liquefied gas, means for evaporating and heating the liquefied gas or for heating the liquefied gas to form a supercritical fluid, and introducing this stream into a means for producing electricity. The means for compressing a gas may include sources of electricity from renewable energy sources. A method of storing energy may comprise (a) compressing and liquefying air using energy from a renewable energy source; and (b) subsequently expanding vapor generated from the liquefied air through an expander to drive a generator and produce electricity. Various systems and methods disclosed herein allow electricity from renewable sources and produced during off-peak periods to be utilized during peak demand periods for electricity with low capital and installed costs.

This application claims the benefit of priority to U.S. App. Ser. No. 61/278,727 entitled “Renewable Wind Power Storage Utilizing Liquid Air”, inventor Ralph Greenberg, filed Oct. 13, 2009, the content of which is incorporated in its entirety as if recited in full below.

### BACKGROUND AND SUMMARY

Electrical generators fueled by renewable energy may operate during periods of peak demand for electricity as well as during off-peak periods. One of the challenges today is to store energy generated from a renewable source for use during periods when demand is high.

The different forms of renewable energy do not necessarily lead to similar energy storage systems. Each form of renewable energy production presents unique issues to be addressed. In some, excess electrical energy is available only during daylight periods. In others, excess electrical energy may be available at essentially constant power. In still others, excess electrical energy will peak and wane.

A power storage and supply system as disclosed herein may include a storage vessel to contain liquefied gas or vapor (such as nitrogen, air, mixture of nitrogen and air, oxygen, carbon dioxide, or other gas or vapor) as a working fluid used to generate electricity. The system may be an open system, in which the liquefied gas or vapor after used to generate electricity is discharged as the substance or chemical compound that was liquefied, or the system may be a closed system in which the substance is recycled and used multiple times. Any system as disclosed herein may optionally be configured to utilize the gas or vapor without combusting the gas or vapor.

The power supply system also includes one or more heat exchangers that extract heat from one stream of the substance and transfer it to a second stream of the substance.

In one instance, disclosed is a system comprising
a) a gas compressor
b) a gas expander in communication with an electric generator
c) a storage vessel capable of storing liquefied gas
d) a liquefied-gas pump in fluid communication with the storage vessel via conduit
e) a first heat exchanger having a first heat exchange side and a second heat exchange side,
   i) the first heat exchange side having conduit configured to
      (1) receive compressed gas from the gas compressor to liquefy the compressed gas and
      (2) discharge the liquefied gas to the storage vessel and/or to recycle the liquefied gas to the inlet side of the liquefied-gas pump
   ii) the second heat exchange side having conduit configured to
      (1) receive the liquefied gas from the liquefied-gas pump and
      (2) discharge the liquefied gas in liquid or gaseous form to the gas expander to generate electricity using the electric generator, and
f) an electricity source in electrical communication with the gas compressor.

Various other heat exchangers and equipment may be incorporated into the system, as more fully described below and as specified in the claims.

The substance used as a working medium in any method or system may be a gas or vapor of a single chemical compound, or the substance may be a mixture of chemical compounds. In one instance, the substance is air-derived and therefore may be one or more of the gases found in dry air (e.g. dry air itself, nitrogen, oxygen, carbon dioxide, or mixture of any of these gases).

The power supply system also includes a compressor to compress the gas or vapor in a compression stage of the liquefaction process. The compressor may be powered by electricity from a source of renewable energy, or the compressor may be powered using fossil fuel-generated electricity generated during periods outside of peak usage time.

Electricity powering the gas compressor may be generated using wind power as the source of renewable energy. Alternatively or additionally, electricity used to power the gas compressor may be generated using a combustible biofuel such as a biodiesel fuel. The electricity used to power the gas compressor may also or instead be generated using photovoltaic panels, geothermal energy, ocean waves, solar thermal energy-based electricity generation, or other form of renewable energy. In some instances, the system and methods discussed herein utilize electricity from an irregular supply of renewable energy, such as wind energy. In some instances, the system and methods discussed herein utilize e.g. hydroelectric or nuclear energy-generated electricity.

In one instance, a system as disclosed herein may comprise
1) a liquefied gas production unit
2) a storage tank or tanks for the storage of produced liquefied gas
3) a system or means for producing electric power from the stored liquefied gas during peak demand times, including a heat exchanger for vaporization, one or more expanders connected to electric generators, and piping, ducting, and/or other conduit
4) a source of electric power to run the liquefied gas production unit during off-peak (low electric cost) times to produce and store liquefied gas that can be used during peak (high electric value) times to produce electric power
5) a liquefied gas generation system intermediate the storage tank and the system or means for producing power which comprises one or more heat exchangers to use compressor-rejected heat and/or heat from ambient air to increase temperature of the gas for power generation in the system or means for producing electric power and at the same time recover heat from the vaporized liquid gas to produce additional liquefied gas.

Also disclosed herein are various methods of storing energy and generating electricity. In one instance, a method comprises storing energy using a condensate comprising
i) converting electrical energy generated by e.g. a renewable energy source into pressure energy by pressurizing a working gas to produce a heated, pressurized gas stream
ii) producing a first condensate stream by removing heat from the heated, pressurized gas stream using a second condensate stream, wherein the first condensate stream is in fluid communication with the second condensate stream and wherein the first condensate stream and the second condensate stream each form a part of said condensate.

A method of generating electricity includes a method of storing energy as discussed above and further comprising evaporating the second condensate stream and driving an expander-generator to generate electricity.

Also disclosed herein is a method of storing energy comprising
a) compressing and liquefying air using energy from a renewable energy source;
b) subsequently expanding vapor generated from the liquefied air through an expander to drive a generator and produce electricity.

Further, disclosed herein is a method of using heat gained when compressing a gas using electricity generated by a renewable energy source comprising
a) vaporizing a condensate of the gas to generate vapor;
b) heating the vapor using said heat gained during compression to form heated vapor;
c) expanding the heated vapor in a first stage of an expander, thereby forming a cooled vapor;
d) heating the cooled vapor using said heat gained during compression to form reheated vapor;
e) expanding the reheated vapor through a second stage of the expander; and
f) generating electricity from rotation of a generator connected to at least one of said first stage and said second stage.

Another method disclosed herein is a method comprising
a) simultaneously (1) removing liquefied air from a storage vessel and expanding vaporized air generated from the liquefied air through an expander-generator to generate electricity; and (2) replenishing the storage vessel with liquefied air generated using electricity generated by a renewable source or mixing said liquefied air generated using electricity generated by a renewable source with said liquefied air from the storage vessel; and
b) simultaneously with acts specified in a) above, using heat energy generated during the process of liquefying the air to drive the expander-generator.

In addition, disclosed is a method of generating high-value electrical energy using a condensate comprising
a) converting first electrical energy into pressure energy by pressurizing a working gas to produce a heated, pressurized gas stream
b) removing sufficient heat from the heated, pressurized gas stream using a first condensate stream to condense the heated, pressurized gas stream into a second condensate stream while simultaneously vaporizing the first condensate stream to form a vaporized condensate stream
c) using the vaporized condensate stream to generate said high-value electrical energy.

Further, a method of generating high-value electrical energy using a condensate may comprise
a) converting first electrical energy into pressure energy by pressurizing a working gas to produce a heated, pressurized gas stream
b) removing sufficient heat from the heated, pressurized gas stream using a first condensate stream to condense the heated, pressurized gas stream into a second condensate stream,
c) heating and maintaining the first condensate stream at supercritical conditions, and
d) using the supercritical fluid to generate said high-value electrical energy.

Any of the methods disclosed herein may optionally utilize the gas or vapor without change in its chemical makeup. Any of the methods as disclosed herein may optionally be performed without combusting the vapor or gas.

These and other systems and methods are described more fully herein.

### BRIEF DESCRIPTION OF THE FIGURES

FIG. 1 is a process flow diagram that depicts many aspects of the technical innovations disclosed herein.

FIG. 2 is a process flow diagram that depicts a second configuration of a renewable power storage system.

FIG. 3 is a process flow diagram depicting a third configuration of a renewable power storage system.

FIG. 4 is a process flow diagram depicting a fourth configuration of a renewable power storage system.

FIG. 5 is a process flow diagram depicting a fifth configuration of a renewable power storage system.

### DETAILED DESCRIPTION AND BEST MODE

Various configurations and methods are discussed herein. The invention is not limited to these configurations, and thus the claims are to be given their broadest reasonable interpretation consistent with the discussion and illustrations provided herein.

By way of example and for better understanding, the entire open system depicted in the figures and various modes of operation are discussed. This discussion is then followed by further explanations of various subcombinations and processes disclosed herein.

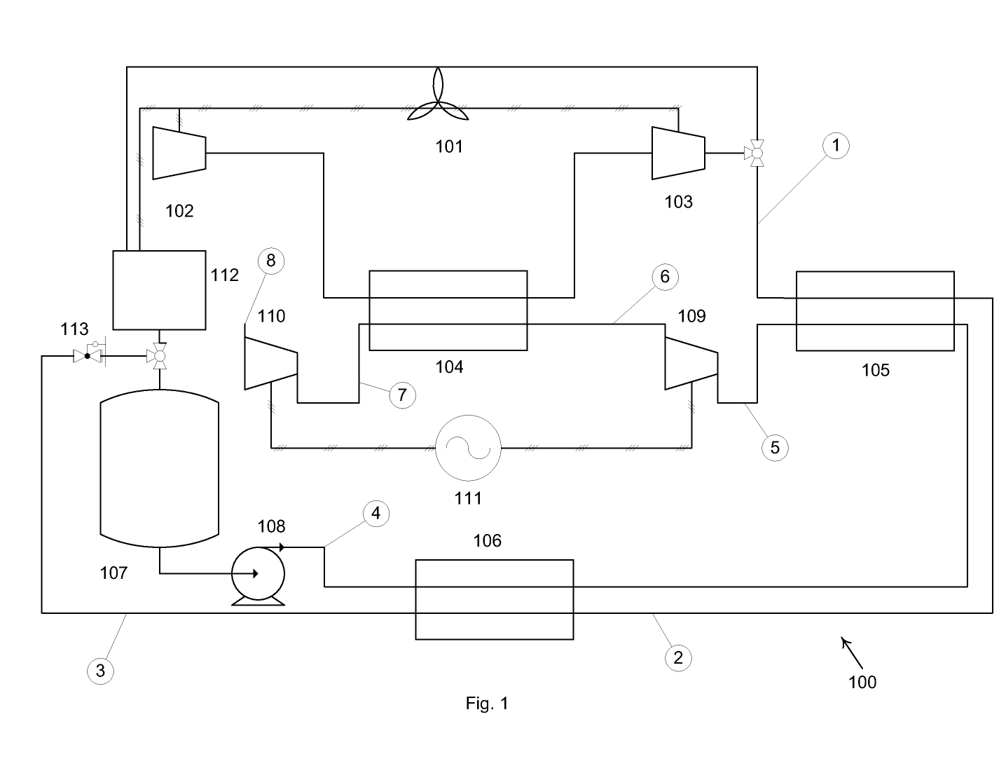

The power supply system 100 depicted in FIG. 1 has a source of electricity 101 that, in all instances discussed herein, is generated from a renewable energy source (e.g. wind power or other renewable energy source discussed herein) or other power supply that does not utilize fossil fuel-generated electricity during peak demand periods. The renewable energy-powered generator 101 is in electrical communication with a compressor, such as the two-stages 102 and 103 of the compressor depicted in FIG. 1. (The compressor may of course be a single-stage compressor or other multi-stage compressor such as a three- or four-stage compressor. The compressor may instead be multiple single-stage or multi-stage compressors.)

During peak electricity demand periods when electricity is of high value, a first stream of gas (e.g. air or another of the gases or vapors discussed herein) compressed by the compressor may be cooled between compression stages by passing the first stream of gas through a first heat exchanger 104, second heat exchanger 105, and third heat exchanger 106 to exchange heat with a second stream of the gas of the same chemical composition. If the first stream of gas is not liquefied or is less than e.g. 60% liquefied, the first stream may be further cooled by transferring additional heat from it to the second stream of the gas in one or more additional heat exchangers. The liquefied gas may enter a storage vessel 107 once pressure has been reduced using flash valve 113.

The second stream of liquefied gas may be drawn from the storage vessel 107 and pumped via pump 108 through heat exchangers 106 and 105 to heat the second stream. The second stream passes through e.g. a first stage 109 of multi-stage expander/generator or multiple expander/generators 109 and 110 to generate additional electricity via their generator or generators depicted as 111. The second stream of gas may be reheated in heat exchanger 104, expanded through the second stage 110 of the expander/generator, and then be discharged to atmosphere in the open system depicted in FIG. 1 or forwarded to an optional accumulator and optionally returned to the compressor 102 for further use if the system is a closed system.

The expander-generator may have multiple stages (in some instances equal in number to the number of stages in the compressor and in some instances different from the number of stages in the compressor). There may therefore be multiple heat exchangers to reheat the second stream of gas between expansion stages.

During periods of peak demand for electricity, the amount of liquefied gas in the storage vessel decreases because the rate at which the second stream of liquefied gas is drawn from the vessel is greater than the rate at which the first stream of liquefied gas enters the vessel. The expander-generator produces electricity during peak time periods and can be stopped during off-peak periods. Electricity generated by the expander-generator during use can supplement or replace the electricity from the renewable source powering the gas compressor stages 102 and 103.

Once demand for electricity drops below peak electricity demand, the expander-generator and liquid gas pump are shut down, and a portion of the electricity generated by the renewable energy source powers the gas compressor stages 102 and 103 and an electrically-powered liquefier 112 to replenish the storage vessel with liquefied gas.

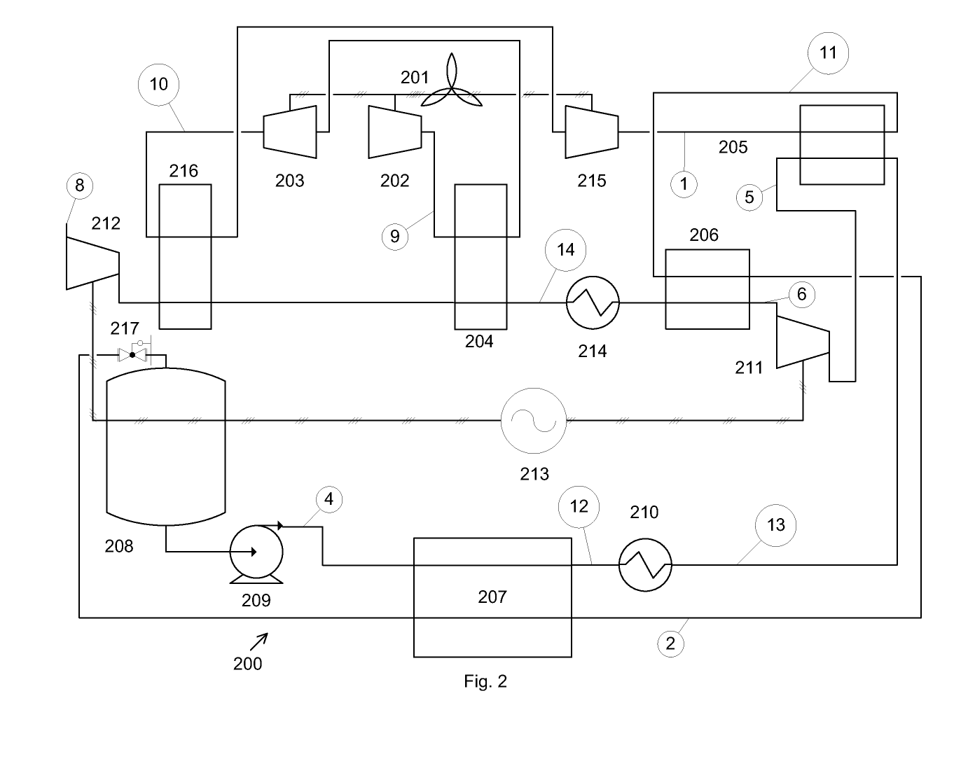

FIG. 2 illustrates a power supply system similar in some regards to that of FIG. 1. Electricity from wind power or other renewable or inexpensive power source 201 powers first 202, second 203, and third 215 stages of a multi-stage compressor, which compress a gas (e.g. air or another of the gases or vapors discussed herein). As above, the compressor may be a single-stage compressor or other multi-stage compressor such as a two- or four-stage compressor. The compressor may instead be multiple single-stage or multi-stage compressors.

During peak electricity demand periods, a first stream of gas compressed by the compressor may be cooled between compression stages by passing the first stream of gas through a heat exchanger 204 and through heat exchangers 216, 205, 206, and 207 subsequent to the second stage 203 of the compressor to exchange heat with a second stream of the gas of the same chemical composition. The first stream may be cooled further by using additional heat exchangers as desired. The liquefied gas may enter a storage vessel 208 once pressure has been reduced using flash valve 217.

The second stream of liquefied gas may be drawn from the storage vessel 208 and pumped via pump 209 through heat exchangers 207, 210, and 205 to heat the second stream. In some instances, one or more of the heat exchangers (e.g. 210, 214 in FIG. 2) use an external source of heat such as ambient air or heated water or other heat exchange fluid to warm the second stream as it passes through that heat exchanger. The heat exchange fluid may be approximately ambient temperature (e.g. within 15° F. or 8.5° C.). The second stream passes through e.g. a first stage 211 of multi-stage expander/generator or multiple expander/generators 211 and 212 to generate additional electricity via their generator or generators depicted as 213 in FIG. 2. The second stream of gas may be reheated in heat exchangers 214, 204, and 216 and expanded through the second stage 212 of the expander/generator, and then be discharged to atmosphere in the open system depicted in FIG. 2 or forwarded to an optional accumulator and optionally returned to the compressor 202 for further use if the system is a closed system.

As for the system described above in conjunction with FIG. 1, the expander-generator may have multiple stages (in some instances equal in number to the number of stages in the compressor and in some instances different from the number of stages in the compressor). There may therefore be multiple heat exchangers to reheat the second stream of gas between expansion stages.

Once demand for electricity drops below peak electricity demand, the expander-generator and liquefied gas pump are shut down, and a portion of the electricity generated by the renewable energy source powers the gas compressor stages 202 and 203 and an electrically-powered liquefier (not shown for sake of clarity) to replenish the storage vessel with liquefied gas.

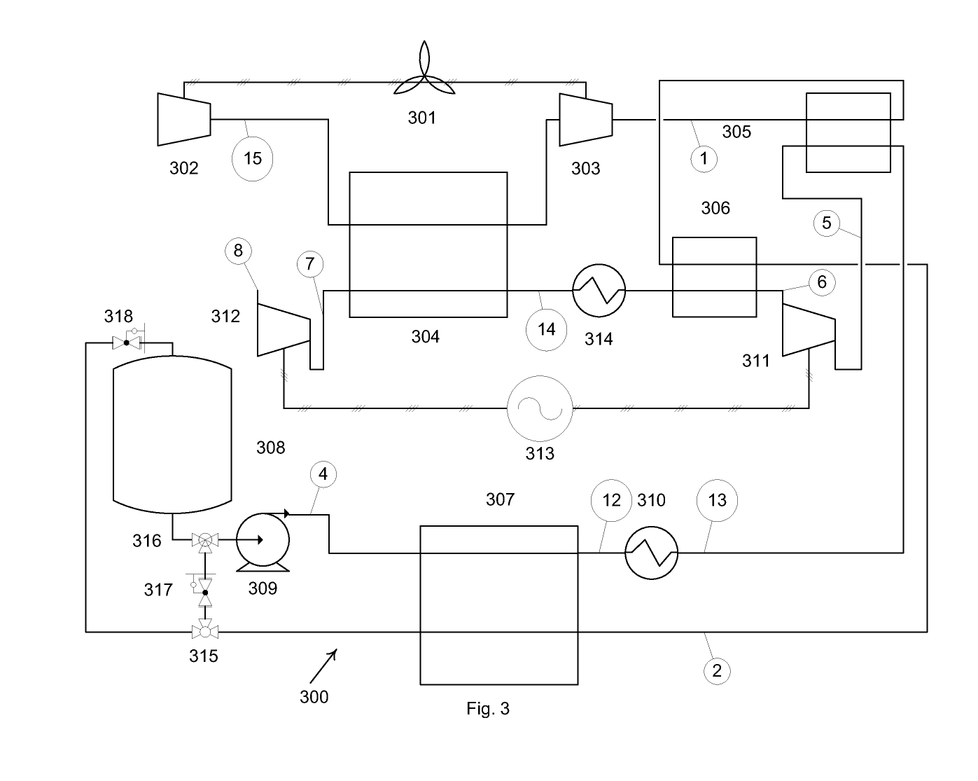

FIG. 3 depicts a power supply system similar to the system of FIG. 2. Electricity from wind power or other renewable or inexpensive power source 301 powers first 302 and second 303 stages of a multi-stage compressor, which compress a gas (e.g. air or another of the gases or vapors discussed herein). As above, the compressor may be a single-stage compressor or other multi-stage compressor such as a three- or four-stage compressor. The compressor may instead be multiple single-stage or multi-stage compressors.

During peak electricity demand periods, a first stream of gas compressed by the compressor may be cooled between compression stages by passing the first stream of gas through a heat exchanger 304 and through heat exchangers 305, 306, and 307 subsequent to the second stage 303 of the compressor to exchange heat with a second stream of the gas (in gaseous, liquid, or supercritical fluid form) of the same chemical composition. The first stream may be cooled further by using additional heat exchangers as desired. The liquefied gas may pass through three-way valve 315 and flash valve 318 prior to entering a storage vessel 308 to be mixed with other of the liquefied gas retained in the vessel.

The second stream of liquefied gas may be drawn from the storage vessel 308 through three-way valve 316 and pumped via pump 309 through heat exchangers 307, 310, and 305 to heat the second stream. In some instances, one or more of the heat exchangers (e.g. 310 and 314 in FIG. 3) use an external source of heat such as ambient air or heated water or other heat exchange fluid to warm the second stream as it passes through that heat exchanger. The heat exchange fluid may be approximately ambient temperature (e.g. within 15° F. or 8.5° C.). The second stream passes through e.g. a first stage 311 of multi-stage expander/generator or multiple expander/generators 311 and 312 to generate additional electricity via their generator or generators depicted as 313 in FIG. 3. The second stream of gas may be reheated in heat exchangers 314 and 304, expanded through the second stage 312 of the expander/generator, and then be discharged to atmosphere in the open system depicted in FIG. 3 or forwarded to an optional accumulator and optionally returned to the compressor 302 for further use if the system is a closed system.

As for the system described above in conjunction with FIG. 1, the expander-generator may have multiple stages (in some instances equal in number to the number of stages in the compressor and in some instances different from the number of stages in the compressor). There may therefore be multiple heat exchangers to reheat the second stream of gas between expansion stages.

Once demand for electricity drops below peak electricity demand, the expander-generator and liquefied gas pump are shut down, and a portion of the electricity generated by the renewable energy source powers the gas compressor stages 302 and 303 and an electrically-powered liquefier (not shown for sake of clarity) to replenish the storage vessel with liquefied gas.

The system depicted in FIG. 3 also provides for immediate recycle of condensed gas (if desired, the conduit from three-way valve 315 to the storage vessel can be eliminated). Instead of conveying the liquefied gas to the storage vessel 308, three-way valve 315 diverts the first stream of liquefied gas to three-way valve 316, which mixes liquefied gas from vessel 308 and liquefied gas from three-way valve 315 to provide the second stream of liquefied gas drawn into pump 309. A reducing valve 317 or other throttling valve may be used to reduce the pressure of the first stream to be approximately equal to that of the liquid from storage vessel 316. Recycling the liquefied gas immediately helps to avoid loss of liquefied gas to vaporization that can occur in vessel 308, thereby increasing efficiency. A vapor/liquid separator may optionally be inserted between valves 317 and 316 or between valve 317 and pump 309 to remove any vapor created when flashing the liquid stream to a lower pressure.

A system as illustrated in FIG. 3 may easily have a third compression stage similar to the third compression stage depicted in FIG. 2. In this instance, the gas emerging from the third stage may be used to heat the fluid (gas, liquid, or supercritical fluid) nearest to the inlet of the first stage of the expander-compressor. The heat from the second stage of compression may be used to heat the expanded gas received from the first stage prior to that gas being utilized in the second stage of the expander-compressor.

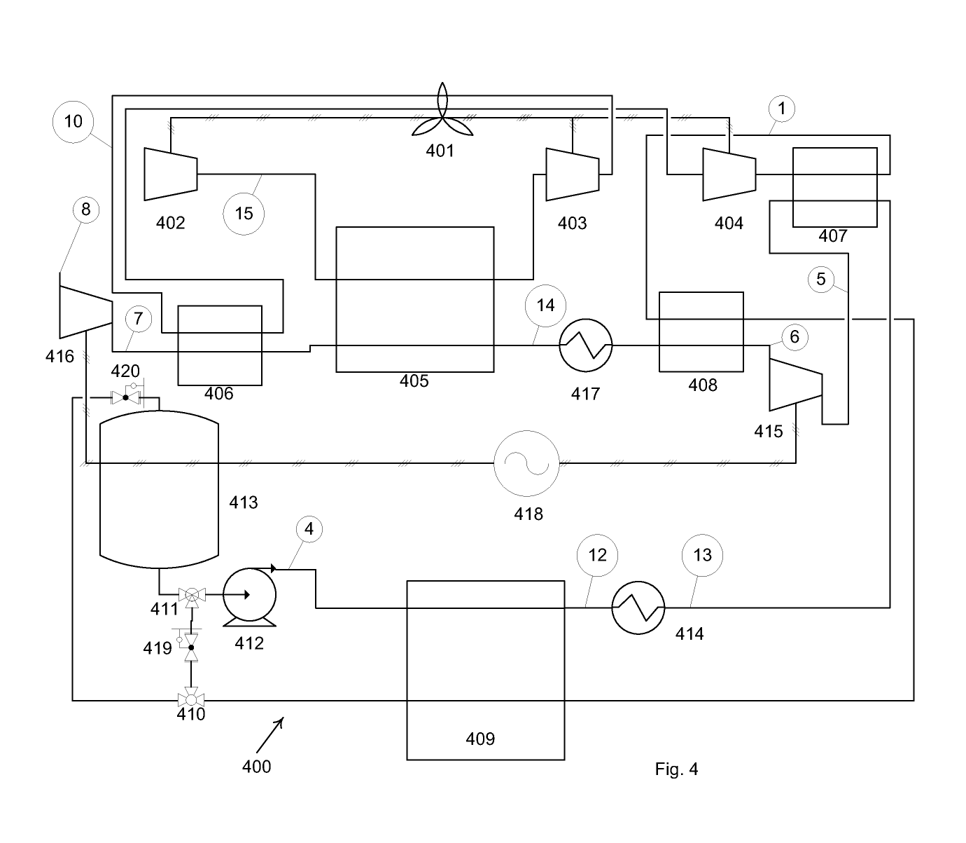

FIG. 4 illustrates a power supply system 400 having gas compression in three stages. A renewable energy source or relatively inexpensive source of electricity 401 powers stages 402, 403, and 404 of the gas compressor depicted in FIG. 4. As noted for FIG. 1, the compressor may be a single-stage compressor or other multi-stage compressor such as a two- or four-stage compressor. The compressor may be multiple single-stage or multi-stage compressors.

During peak demand periods for electricity, a first stream of gas (e.g. air or another of the gases or vapors discussed herein) may be cooled between compression stages by passing the first stream of gas through a heat exchanger 405, second heat exchanger 406, third heat exchanger 407, fourth heat exchanger 408, and heat exchanger 409 to exchange heat with a second stream of the gas of the same chemical composition. Additional heat exchangers may be used as desired to assure that the first stream is liquefied to the desired extent. The liquefied gas may be reused immediately by diverting the first liquid stream through three-way valve 410, mixing with additional liquefied gas from vessel 413 in three-way valve 411, and pumping the mixed liquefied gas stream through pump 412. Reducing valve 419 may reduce the pressure of the first stream of liquefied gas from valve 410 to a pressure approximately equal to the pressure of liquefied gas exiting vessel 413. A vapor/liquid separator may be present between valves 419 and 411 or between valve 419 and pump 412 to separate any vapor formed by flashing the liquid stream from valve 410. Optionally, instead of diverting liquefied gas to three-way valve 411, liquefied gas may flow through three-way valve 410 and flash valve 420 before entering vessel 413 from which pump 412 draws the second stream of liquefied gas through three-way valve 411.

Pump 412 pumps the second stream of liquefied gas through heat-exchangers 409, 414, and 407 to heat the second stream. The second stream passes through e.g. the first stage 415 of a multi-stage expander/generator or multiple expander/generators 415, 416 and is reheated by heat exchangers 417, 405, and 406 before passing through the second stage of the multi-stage expander/generator. Generator 418 may be a single generator driven by e.g. a shaft attached to the multi-stage expander portion, or generator 418 may be individual generators driven by each of the stages.

In the system depicted in FIG. 4, the second stream of liquefied gas may be pumped to critical or supercritical pressure by pump 412, and this second stream may emerge as a supercritical fluid from heat exchanger 409 to be further heated by heat exchangers 414 and 407. The supercritical fluid vaporizes to drive expander/generator 415.

During periods of peak demand for electricity, the amount of liquefied gas in the storage vessel decreases because the rate at which the second stream of liquefied gas is drawn from the vessel is greater than the rate at which the first stream of liquefied gas enters the vessel. The expander-generator produces electricity during peak time periods and can be stopped during off-peak periods. Electricity generated by the expander-generator during use can supplement or replace the electricity from the renewable source powering the gas compressor stages 402, 403, and 404.

Once demand for electricity drops below peak electricity demand, the expander-generator and liquefied gas pump are shut down, and a portion of the electricity generated by the renewable energy source powers one or more of the gas compressor stages 402, 403, and 404 and an electrically-powered liquefier (not illustrated for sake of clarity) to replenish the storage vessel with liquefied gas.

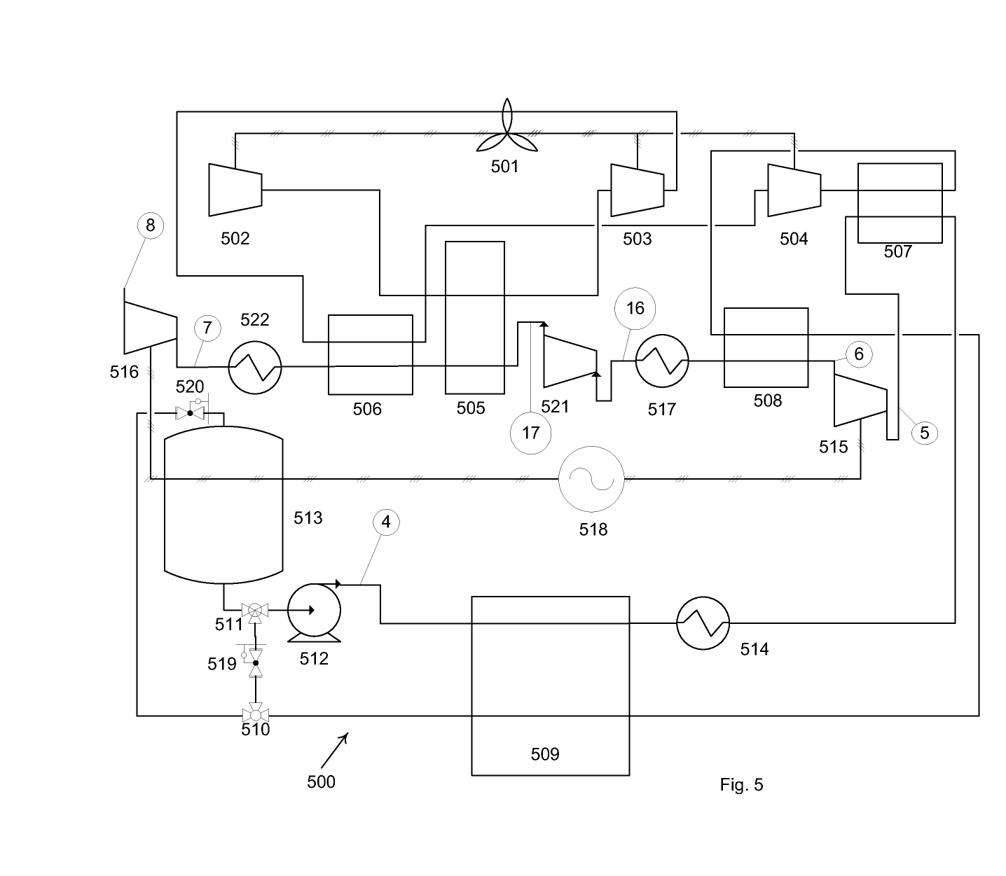

FIG. 5 illustrates a power supply system 500 having gas compression in three stages and gas expansion in three stages. A renewable energy source or relatively inexpensive source of electricity 501 powers stages 502, 503, and 504 of the gas compressor depicted in FIG. 5. As noted for FIG. 1, the compressor may be a single-stage compressor or other multi-stage compressor such as a two- or four-stage compressor. The compressor may be multiple single-stage or multi-stage compressors.

During peak demand periods for electricity, a first stream of gas (e.g. air or another of the gases or vapors discussed herein) may be cooled between compression stages by passing the first stream of gas through a heat exchanger 505, second heat exchanger 506, third heat exchanger 507, fourth heat exchanger 508, and heat exchanger 509 to exchange heat with a second stream of the gas of the same chemical composition. Additional heat exchangers may be used as desired to assure that the first stream is liquefied to the desired extent. The liquefied gas may be reused immediately by diverting the first liquid stream through three-way valve 510, mixing with additional liquefied gas from vessel 513 in three-way valve 511, and pumping the mixed liquefied gas stream through pump 512. Reducing valve 519 may reduce the pressure of the first stream of liquefied gas from valve 510 to a pressure approximately equal to the pressure of liquefied gas exiting vessel 513. A vapor/liquid separator may be present between valves 519 and pump 512 to separate any vapor formed by flashing the liquid stream with valve 519. Optionally, instead of diverting liquefied gas to three-way valve 511, liquefied gas may flow through three-way valve 510 and through pressure-reducing valve 520 to enter vessel 513 from which pump 512 draws the second stream of liquefied gas through three-way valve 511.

Pump 512 pumps the second stream of liquefied gas through heat-exchangers 509, 514, and 507 to heat the second stream. The second stream passes through e.g. the first stage 515 of a multi-stage expander/generator or multiple expander/generators 515, 516, 521, is reheated by heat exchanger 517 before passing through the second stage of the expander/generator 521, and is subsequently reheated by heat exchangers 505, 506, and 522 before passing through the third stage 516 of the multi-stage expander/generator. Generator 518 may be a single generator driven by e.g. a shaft attached to the multi-stage expander portion, or generator 518 may be individual generators driven by each of the stages.

In the system depicted in FIG. 5, the second stream of liquefied gas may be pumped to critical or supercritical pressure by pump 512, and this second stream may emerge as a supercritical fluid from heat exchanger 509 to be further heated by heat exchangers 514 and 507. The supercritical fluid vaporizes to drive expander/generator 515.

During periods of peak demand for electricity, the amount of liquefied gas in the storage vessel decreases because the rate at which the second stream of liquefied gas is drawn from the vessel is greater than the rate at which the first stream of liquefied gas enters the vessel. The expander-generator produces electricity during peak time periods and can be stopped during off-peak periods. Electricity generated by the expander-generator during use can supplement or replace the electricity from the renewable source powering the gas compressor stages 502, 503, and 504.

Once demand for electricity drops below peak electricity demand, the expander-generator and liquefied gas pump are shut down, and a portion of the electricity generated by the renewable energy source powers one or more of the gas compressor stages 502, 503, and 504 and an electrically-powered liquefier (not illustrated for sake of clarity) to replenish the storage vessel with liquefied gas.

The table below provides estimated operating conditions at the positions indicated by the circled numbers in the figures, assuming an open system using dehydrated air with an inlet temperature to the first compressor stage of 80° F. (26.7° C.). Pressure is in absolute units:

| Circled | | | | | | | | | | |
|---|---|---|---|---|---|---|---|---|---|---|
| number | FIG. 1 | | FIG. 2 | | FIG. 3 | | FIG. 4 | | FIG. 5 | |
| 1 | 275 F. | (135.0 C.) | 364 F. | (184.4 C.) | 334 F. | (167.8 C.) | 338 F. | (170.0 C.) | | |
| | 100 psi | (6.8 atm) | 352 psi | (23.9 atm) | 100 psi | (6.8 atm) | 260 psi | (17.7 atm) | | |
| 2 | 100 F. | (37.8 C.) | −20 F. | (−28.9 C.) | −20 F. | (−28.9 C.) | | | | |
| 3 | −308 F. | (−188.9 C.) | | | | | | | | |
| 4 | −312 F. | (−191.1 C.) | −312 F. | (−191.1 C.) | −315 F. | (−192.8 C.) | −315 F. | (−192.8 C.) | −315 F. | (−192.8 C.) |
| | 250 psi | (17.0 atm) | 450 psi | (30.6 atm) | 300 psi | (20.4 atm) | 1200 psi | (81.6 atm) | 1200 psi | (81.6 atm) |
| 5 | 270 F. | (132.2 C.) | 187 F. | (86.1 C.) | 115 F. | (46.1 C.) | 141 F. | (60.6 C.) | 70 F. | (21.1 C.) |
| | 250 psi | (17.0 atm) | 443 psi | (30.1 atm) | 293 psi | (19.9 atm) | 1193 psi | (81.2 atm) | 1195 psi | (81.3 atm) |
| 6 | 100 F. | (37.8 C.) | −32 F. | (−35.6 C.) | −41 F. | (−40.6 C.) | −110 F. | (−78.9 C.) | −95 F. | (−70.6 C.) |
| | 61 psi | (4.1 atm) | | | | | 132 psi | (9.0 atm) | 275 psi | (18.7 atm) |
| 7 | 270 F. | (132.2 C.) | | | 109 F. | (42.8 C.) | 205 F. | (96.1 C.) | 70 F. | (21.1 C.) |
| | 60 psi | (4.1 atm) | | | 73 psi | (5.0 atm) | 124 psi | (8.4 atm) | | |
| 8 | 90 F. | (32.2 C.) | 45 F. | (7.2 C.) | −74 F. | (−64.4 C.) | −60 F. | (−51.1 C.) | −87 F. | (−66.1 C.) |
| | 14.7 psi | (1 atm) | 14.7 psi | (1 atm) | 14.7 psi | (1 atm) | 14.7 psi | (1 atm) | 14.7 psi | (1 atm) |
| 9 | | | 340 F. | (171.1 C.) | | | | | | |
| | | | 44 psi | (3.0 atm) | | | | | | |
| 10 | | | 366 F. | (185.6 C.) | | | 347 F. | (175 C.) | | |
| | | | 123 psi | (8.4 atm) | | | 100 psi | (6.8 atm) | | |
| 11 | | | 100 F. | (37.8 C.) | | | | | | |
| | | | 350 psi | (23.8 atm) | | | | | | |
| 12 | | | −230 F. | (−145.6 C.) | −258 F. | (−161.1 C.) | −222 F. | (−141.1 C.) | | |
| 13 | | | 70 F. | (21.1 C.) | 70 F. | (21.1 C.) | 70 F. | (21.1 C.) | | |
| 14 | | | 70 F. | (21.1 C.) | 70 F. | (21.1 C.) | 70 F. | (21.1 C.) | | |
| 15 | | | | | 315 F. | (157.2 C.) | 303 F. | (150.6 C.) | | |
| | | | | | 40 psi | (2.7 atm) | 38 psi | (2.6 atm) | | |
| 16 | | | | | | | | | 70 F. | (21.1 C.) |
| | | | | | | | | | 272 psi | (18.5 atm) |
| 17 | | | | | | | | | −88 F. | (−66.7 C.) |
| | | | | | | | | | 64 psi | (4.4 atm) |

Operational Modes

The pressure of the second stream of liquefied gas may be less than the critical pressure for that gas as the stream emerges from the pump used to pressurize the liquefied gas stream. In some instances, the pressure of the second stream is less than the pressure required to maintain the second stream in liquid form throughout the heat exchanger downstream of the pump. The liquefied gas may have a pressure of less than e.g. 500 psia, 400 psia, 300 psia, or 250 psia as the liquefied gas emerges from the pump. A lower gas pressure such as a pressure of 300 psia or less or 250 psia or less may provide greater net electrical power than higher pressures will. The second stream evaporates in heat exchangers 106, 207, 409, and 509 of FIG. 1-5, and therefore the heat exchanger has a portion in which the second stream is essentially at constant temperature in the portion of the heat exchangers where the second stream evaporates.

A heat exchange system can optionally provide the heat from a first stream of compressed gas of highest enthalpy compared to the liquefied gas discharged from the first heat exchanger to the second stream of gas immediately prior to the second stream of gas entering the first stage of the expander-generator. The heat exchange system may optionally provide heat from the first stream of compressed gas of second highest enthalpy (compared to the liquefied gas discharged from the first heat exchanger) to the second stream of gas immediately prior to the second stream of gas entering the second stage of the expander-generator.

The first heat exchanger may be a condenser/vaporizer, in which the first stream is condensed and the second stream is vaporized. Since condensation and vaporization occur at constant temperature for a pure material (and at the same temperature where the first gas stream and the second gas stream are of identical chemical composition), the latent heat liberated during condensation can be used to vaporize the gas with little loss of heat, improving efficiency. The same is generally true for air, in which its major components condense and vaporize within a relatively small range of temperatures. In this instance, it can be advantageous to condense and vaporize only in the first heat exchanger for efficiency in heat use as well as in conveyance.

Alternatively, the pressure of the second stream of liquefied gas may be critical or supercritical as the stream emerges from the pump used to pressurize the liquefied gas stream. By pressurizing the second stream to its critical pressure or above, the system avoids using heat to evaporate the liquefied gas in heat exchangers prior to introducing the liquefied gas stream to the first stage of the expander-generator. The second stream therefore continues to increase in temperature to produce a stream of liquefied gas of higher temperature exiting the first heat exchanger after the pump rather than maintain temperature at the boiling point of the gas through much or all of this heat exchanger. Various heat exchangers through which liquid or supercritical fluid flows may therefore be made smaller than heat exchangers in which the second stream is a gas to decrease capital cost.

The temperature of the second stream emerging from the first heat exchanger may be less than the critical temperature for the liquefied gas and will therefore remain a liquid at this point. Alternatively, the temperature of the second stream emerging from the first heat exchanger may be greater than the critical temperature for the liquefied gas, and the second stream will therefore be a supercritical fluid at the exit of the first heat exchanger.

Additional heat exchangers may be used to increase the temperature to either convert the liquid of the second stream to a supercritical fluid or to further increase the temperature of the supercritical fluid. Once the supercritical fluid of the second stream is expanded through the first stage of the expander-generator, the second stream remains a gas as the second stream flows through subsequent stages and through the last stage of the expander-generator.

The temperature of the first stream entering the heat exchangers (regardless whether the second stream is below, at, or above critical pressure) may exceed the boiling point for the first stream. In this instance, the first stream condenses at least partially in heat exchangers 106, 207, and 409, and therefore the temperature of the first stream remains essentially constant in a portion of heat exchangers 106, 207, 307, and 409. If no additional heat exchangers are positioned between these heat exchangers and the pump, preferably these heat exchangers have a portion in which the condensed liquid of the first stream is further chilled to or near the temperature of liquefied gas in the storage vessel.

Any of the systems discussed above may optionally include one or more heat exchangers that utilize a low-value heat stream to heat the liquefied gas or vapor formed from liquefied gas (see, e.g. heat exchangers 210, 214, 310, 314, 414, 417, 514, 517, and 522 of FIG. 2-5). Low-value heat streams include waste heat streams from adjacent facilities. Additionally or alternative, a low-value heat stream may be ambient air. Use of ambient air enables the system to be located in remote locations where waste heat from other processes is unavailable. Consequently, heat from ambient air or one or more waste-heat streams is used in addition to heat from the compressors in generating additional electrical power.

Any of the systems discussed above may optionally be a “stand-alone” or “drop-in” system that does not require e.g. a cryogenic air separation plant that separates air into its constituent chemical components to be connected as part of system, especially if air is used as the working fluid. Consequently, a stand-alone system does not require a waste heat stream from a power plant or cryogenic air or nitrogen from an air separation plant, for instance. Capital cost is therefore considerably lower for this type of system. Further, a system not dependent on a cryogenic air separation plant can be built on smaller portions of land and adjacent to a source of renewable energy such as wind-generated electric power, wave-generated electric power, or other form of renewable or inexpensive energy (e.g. hydropower, nuclear, or fossil-fueled power during periods of low demand for electricity) as discussed herein. Ambient air can be compressed and discharged again to atmosphere, and it is therefore unnecessary in a system where the working fluid is air to provide gas storage tanks. Such system eases installation at facilities not having a gas plant on site as well as locations remote from gas suppliers, and again decreases capital required to purchase and construct the system.

Any of the systems discussed above may optionally have a desiccant or molecular sieve or other gas cleaning/polishing equipment to remove undesired components that e.g. would solidify at the temperatures used in the system or otherwise cause operational or reliability problems.

Any of the systems above may optionally use one or more renewable energy sources exclusively in compressing the gas. Such renewable energy sources include wind-generated, solar-generated, biomass-generated, photovoltaic-generated, wave power-generated, hydroelectric, and geothermal-generated power.

Equipment

Expander/generators may be turbines as depicted in the figures. Alternatively, any one or all of the expander/generators may be reciprocating engines, rotary engine, or other equipment that generates electricity or mechanical movement that can be converted to electricity in a generator. An expander/generator may have one, two, three, or more stages, depending on the amount of electricity to be generated.

One or more of the heat exchangers may be configured as condensers and/or evaporators. For instance, the first heat exchanger in communication with the liquefied gas pump may be a condenser/evaporator configured to convert gas and capture liquid on one heat-exchange side and admit liquid and convey gas from the second heat-exchange side.

Other of the heat exchangers may be configured to exchange heat between two gas streams. For instance, channels through each side of a heat exchanger may be finned to aid in heat transfer.

Heat exchangers may be e.g. plate and fin heat exchangers, fin and tube heat exchangers, tube bundle heat exchangers, shell and tube heat exchangers, or other type or types of heat exchanger suitable to exchange the desired amount of heat at operating conditions between the two fluid streams.

The liquefied gas storage vessel may be positioned above ground or, if desired, beneath the ground. The liquefied gas may be stored at or near atmospheric pressure (e.g. within 10 psia of atmospheric pressure) so that the vessel can be a standard storage vessel for cryogenic liquid. The vessel need not be designed for high-pressure gas storage as in compressed gas storage systems, which helps provide an intrinsically safer system as well as reduced capital cost. The vessel may have a vapor recovery system to capture vapors generated at conditions within the vessel. For instance, the vessel may have a neon, krypton, xenon, and hydrogen recovery system to recover these gases generated by liquefying e.g. ambient air in an open system. These gases may be captured from a liquefied gas storage vessel (e.g. 513) or from a vapor separator between a flash valve (e.g. 519) and liquefied gas pump (e.g. 512) and may be stored separately in a vessel for subsequent use in e.g. neon lighting or hydrogen-powered vehicles respectively. A suitable recovery medium may be e.g. a distillation system or selective adsorbents to separate gases from one another. Such systems are disclosed in e.g. U.S. Pat. No. 2,482,304, U.S. Pat. No. 3,085,379, and U.S. Pat. No. 4,431,432, each of which is incorporated in its entirety as if put forth in full herein.

Conduit interconnecting equipment may be e.g. pipes, ducts, channels, and other equipment as used to convey such fluids, be they liquid, gaseous, or supercritical fluid.

Where the first stream of liquefied gas is recycled as illustrated in FIG. 3-5, there may be an intermediate separation vessel to allow vapor that has not liquefied to separate from the liquid in order to avoid reintroducing vapor into the pump conveying the second stream.

The pump may be a centrifugal, multi-stage centrifugal, diaphragm, piston, pneumatic booster, or other rotating or reciprocal pump.

What is disclosed by way of example and not by way of limitation is:

1. A system comprising
a) a gas compressor
b) a gas expander in communication with an electric generator
c) a storage vessel capable of storing a liquefied gas such as liquefied air, liquefied nitrogen, or a mixture of liquefied air and liquefied nitrogen
d) a liquefied-gas pump in fluid communication with the storage vessel via conduit
e) a first heat exchanger having a first heat exchange side and a second heat exchange side,
   i) the first heat exchange side having conduit configured to
      (1) receive compressed gas from the gas compressor to liquefy the compressed gas and
      (2) discharge the liquefied gas to the storage vessel and/or to recycle the liquefied gas to the inlet side of the liquefied-gas pump
   ii) the second heat exchange side having conduit configured to
      (1) receive the liquefied gas from the liquefied-gas pump and
      (2) discharge the liquefied gas as a supercritical, liquid or gaseous fluid to the gas expander to generate electricity using the electric generator
f) an electricity source in electrical communication with the gas compressor.
   2. A system according to paragraph 1 wherein said electricity source is wind-generated, solar-generated, biomass-generated, geothermal-generated, or nuclear power-generated electricity.
   3. A system according to paragraph 1 or paragraph 2 and further comprising
a) a second heat exchanger having a first heat exchange side and a second heat exchange side, and additionally having
   i) conduit to the first heat exchange side configured to receive the compressed gas exiting a first stage of the gas compressor and convey cooled compressed gas exiting the second heat exchanger to an inlet of a second stage of the gas compressor, and
   ii) conduit to the second heat exchange side configured to receive gas exiting a first stage of the expander-generator and convey reheated gas exiting the second heat exchanger to an inlet of a second stage of the expander-generator.
      4. A system according to any of paragraphs 1-3 and further comprising a third heat exchanger having a first heat-exchange side and a second heat-exchange side and additionally having
a) conduit to the first heat exchange side configured to receive the compressed gas exiting the second stage of the gas compressor and convey cooled compressed gas exiting the third heat exchanger to an inlet of the first heat exchange side of the first heat exchanger, and
b) conduit to the second heat exchange side configured to receive the supercritical, liquid or gaseous fluid from the first heat exchanger and convey heated supercritical, liquid, or gaseous fluid to the expander-generator.
   5. A system according to paragraph 4 wherein the conduit to convey the heated supercritical, liquid, or gaseous fluid to the expander-generator comprises conduit to an inlet of the first stage of the expander-generator.
   6. A system according to paragraph 5 and further comprising a fourth heat exchanger having a first heat-exchange side and a second heat-exchange side and additionally having
a) conduit to the first heat exchange side configured to receive the cooled compressed gas exiting the third heat exchanger and convey further-cooled compressed gas to the inlet of the first heat exchange side of the first heat exchanger, and
b) conduit to the second heat exchange side configured to receive expanded gas discharged by the first stage of the expander-generator and convey reheated gas to the second heat exchange side of the second heat exchanger.
   7. A system according to any of paragraphs 4-6 and further comprising a fifth heat exchanger having a first heat-exchange side and a second heat-exchange side and additionally having
a) conduit to the first heat-exchange side configured to receive the liquefied gas in gaseous form from the second heat-exchange side of the first heat exchanger and convey further heated gas to the second heat-exchange side of the third heat exchanger, and
b) conduit to the second heat-exchange side configured to receive a heating fluid at approximately ambient temperature.
   8. A system according to paragraph 6 or paragraph 7 and further comprising a sixth heat exchanger having a first heat-exchange side and a second heat-exchange side and additionally having
a) conduit to the first heat-exchange side configured to receive reheated gas from the second heat-exchange side of the fourth heat exchanger, and
b) conduit to the second heat-exchange side configured to receive a heating fluid at approximately ambient temperature.
   9. A system according to any of paragraphs 1-8 and further comprising a seventh heat exchanger having a first heat exchange side and a second heat exchange side and additionally having
a) conduit to the first heat exchange side configured to receive heated compressed gas from the second stage of the gas compressor and convey cooled compressed gas to an inlet of a third stage of the gas compressor, the third stage of the gas compressor additionally having conduit to convey heated compressed gas to the first side of the third heat exchanger; and
b) conduit to the second heat exchange side configured to
   i) receive the expanded gas from one of (a) the discharge of the first expander-generator directly, (b) the second heat exchange side of the fourth heat exchanger, (c) the first heat exchange side of the sixth heat exchanger, or the second heat exchange side of the second heat exchanger to form additionally heated gas and
   ii) convey the additionally heated gas to the second expander-generator.
      10. A system according to paragraph 4 wherein the third heat exchanger's conduit to convey the heated supercritical, liquid or gaseous fluid to the expander-generator comprises conduit to an inlet of the second stage of the expander-generator.
      11. A system according to paragraph 10 and further comprising
a) a third stage to the gas compressor having conduit to an inlet of the third stage, wherein the conduit receives the cooled compressed gas exiting the first heat exchange side of the third heat exchanger,
b) a fourth heat exchanger having a first heat exchange side and a second heat exchange side,
   i) the first heat exchange side comprising conduit configured to receive compressed gas from a discharge of the third stage of the gas compressor,
   ii) the second heat exchange side comprising conduit to receive the supercritical or liquid fluid from the second heat-exchange side of the first heat exchanger and convey heated supercritical or liquid fluid to the first stage of the expander-generator
c) a fifth heat exchanger having a first heat exchange side and a second heat exchange side,
   i) the first heat exchange side comprising conduit configured to receive cooled compressed gas from the first side of the fourth heat exchanger and provide further-cooled compressed gas to the first heat-exchange side of the first heat exchanger, and
   ii) the second heat exchange side comprising conduit configured to receive expanded gas from the first stage of the expander-generator and convey heated gas to the second heat-exchange side of the second heat exchanger.
      12. A system according to paragraph 11 and further comprising a sixth heat exchanger having a first heat-exchange side and a second heat-exchange side, and additionally having
a) conduit to the first heat exchange side configured to receive heated gas from the second heat exchange side of the fifth heat exchanger and convey further-heated gas to the second heat exchange side of the second heat exchanger, and
b) conduit to the second heat exchange side configured to receive a heating fluid at approximately ambient temperature.
   13. A system according to paragraph 11 or paragraph 12 and further comprising a seventh heat exchanger having a first heat-exchange side and a second heat-exchange side, and additionally having
a) conduit to the first heat exchange side configured to receive the heated supercritical or liquid fluid from the second heat exchange side of the first heat exchanger and convey further heated supercritical or liquid fluid to the second heat exchange side of the fourth heat exchanger, and
b) conduit to the second heat exchange side configured to receive a heating fluid at approximately ambient temperature.
   14. A system according to any paragraph above and further comprising an electrically-powered gas liquefier having conduit to receive compressed gas from a last stage of the gas compressor and to convey liquefied gas to the storage vessel.
   15. A system according to any paragraph above and further comprising conduit from the first heat exchange side of the first heat exchanger to the inlet of the pump to recycle condensed gas.
   16. A system according to any paragraph above wherein the gas is air.
   17. A system according to paragraph 16 wherein the inlet to the gas compressor and the outlet from the expander-generator are each open to atmosphere.
   18. A system according to any of paragraphs 7-17 wherein the second heat exchange side of the fifth and/or sixth heat exchangers is configured to convey ambient air as the heat exchange medium.
   19. A system according to paragraph 9 wherein the second heat exchange side of the seventh heat exchangers is configured to convey ambient air as the heat exchange medium.
   20. A system according any paragraph above wherein the system is not connected to a cryogenic air processing system that separates gas components from air.
   21. A system according to paragraph 20 wherein there is no cryogenic air processing system at the same facility in which the system according to paragraph 20 is located.
   22. A system according to any of paragraphs 1-21 wherein at least one heat exchanger is an air-to-air heat exchanger having an inlet to ambient air on one heat-exchange side of said air-to-air heat exchanger and the other heat-exchange side of said air-to-air heat exchanger receives expanded gas from one of said gas expanders to reheat said expanded gas.
   23. A system according to any of paragraphs 1-22 wherein the fluid discharged from the second heat exchange side of the first heat exchanger comprises a supercritical fluid.
   24. A system according to any of paragraphs 1-22 wherein the fluid discharged from the second heat exchange side of the first heat exchanger comprises a gas.
   25. A method comprising
a) storing energy using a condensate comprising
   i) converting electrical energy generated by a renewable energy source into pressure energy by pressurizing a working gas to produce a heated, pressurized gas stream
   ii) producing a first condensate stream by removing heat from the heated, pressurized gas stream using a second condensate stream, wherein the first condensate stream is in fluid communication with the second condensate stream and wherein the first condensate stream and the second condensate stream each form a part of said condensate.
      26. A method according to paragraph 25 wherein the first condensate stream is formed in a heat exchanger and the second condensate stream removes heat from the heated, pressurized gas stream in the same heat exchanger.
      27. A method according to paragraph 25 or paragraph 26 and further comprising evaporating the second condensate stream and driving an expander-generator to generate electricity.
      28. A method according to paragraph 25 or paragraph 26 wherein at least a portion of the second condensate stream vaporizes as the heated, pressurized stream condenses.
      29. A method according to paragraph 25 or paragraph 26 wherein the second condensate stream does not vaporize as the heated, pressurized gas stream condenses.
      30. A method according to any of paragraphs 25-29 wherein the first condensate stream is immediately recycled and mixed with a third condensate stream to form said second condensate stream.
      31. A method according to any of paragraphs 25-30 wherein heat from ambient air is used to heat the working gas.
      32. A method of storing energy comprising
a) compressing and liquefying air using energy from a renewable energy source;
b) subsequently expanding vapor generated from the liquefied air through an expander to drive a generator and produce electricity.
   33. A method of using heat gained when compressing a gas using electricity generated by a renewable energy source comprising
a) vaporizing a condensate of the gas to generate vapor;
b) heating the vapor using said heat gained during compression to form heated vapor;
c) expanding the heated vapor in a first stage of an expander, thereby forming a cooled vapor;
d) heating the cooled vapor using said heat gained during compression to form reheated vapor;
e) expanding the reheated vapor through a second stage of the expander; and
f) generating electricity from rotation of a generator connected to at least one of said first stage and said second stage.
   34. A method according to paragraph 33 wherein the act of heating the cooled vapor uses heat from a first stage of compression.
   35. A method according to paragraph 33 or paragraph 34 wherein the act specified in step 33.b) uses heat of a stage subsequent to the first stage of compression to heat said vapor.
   36. A method comprising
a) simultaneously (1) removing liquefied air from a storage vessel and expanding vaporized air generated from the liquefied air through an expander-generator to generate electricity; and (2) replenishing the storage vessel with liquefied air generated using electricity generated by a renewable source or mixing said liquefied air generated using electricity generated by a renewable source with said liquefied air from the storage vessel; and
b) simultaneously with acts specified in a) above, using heat energy generated during the process of liquefying the air to drive the expander-generator.
   37. A method according to any method paragraph above wherein the electrical energy generated by the renewable energy source is solely generated by the renewable energy source.
   38. A method according to any method paragraph above wherein the gas is air.
   39. A method of generating high-value electrical energy using a condensate comprising
a) converting first electrical energy into pressure energy by pressurizing a working gas to produce a heated, pressurized gas stream
b) removing sufficient heat from the heated, pressurized gas stream using a first condensate stream to condense the heated, pressurized gas stream into a second condensate stream while simultaneously vaporizing the first condensate stream to form a vaporized condensate stream
c) using the vaporized condensate stream to generate said high-value electrical energy.
   40. A method of generating high-value electrical energy using a condensate comprising
a) converting first electrical energy into pressure energy by pressurizing a working gas to produce a heated, pressurized gas stream
b) removing sufficient heat from the heated, pressurized gas stream using a first condensate stream to condense the heated, pressurized gas stream into a second condensate stream,
c) heating and maintaining the first condensate stream under supercritical conditions, and
d) using the supercritical fluid to generate said high-value electrical energy.
   41. A method according to paragraph 39 or paragraph 40 wherein the first electrical energy comprises electrical energy from a renewable source.
   42. A method according to any of paragraphs 25-40 wherein said working gas is not combusted as part of said method.

Heat exchanger numbering in the claims and paragraphs above is used only to uniquely identify a heat exchanger. Consequently and for example, a “seventh heat exchanger” does not require the presence of seven heat exchangers in the claimed subject matter. The numbering is therefore used only to aid in understanding relative placements and/or relationships of equipment to one another.

While various specific instances of the invention are discussed above, the invention is not limited to those specific instances, and the claims are to be accorded their broadest reasonable interpretation consistent with the discussion and claims herein. The claims form a part of the specification as if each and every claim was recited in the text above.

What is claimed is:

1. A system comprising
a) a gas compressor
b) a gas expander in communication with an electric generator
c) a storage vessel capable of storing liquefied air, liquefied nitrogen, or mixture of liquefied air and liquefied nitrogen
d) a liquefied-gas pump in fluid communication with the storage vessel via conduit
e) a first heat exchanger having a first heat exchange side and a second heat exchange side,
i) the first heat exchange side having conduit configured to
(1) receive compressed gas from the gas compressor to liquefy the compressed gas and
(2) discharge the liquefied gas to the storage vessel and/or to recycle the liquefied gas to the inlet side of the liquefied-gas pump
ii) the second heat exchange side having conduit configured to
(1) receive the liquefied gas from the liquefied-gas pump and
(2) discharge the liquefied gas as a supercritical, liquid or gaseous fluid to the gas expander to generate electricity using the electric generator
f) an electricity source in electrical communication with the gas compressor.

2. A system according to claim 1 wherein said electricity source is wind-generated, solar-generated, biomass-generated, geothermal-generated, or nuclear power-generated electricity.

3. A system according to claim 1 and further comprising
a) a second heat exchanger having a first heat exchange side and a second heat exchange side, and additionally having
i) conduit to the first heat exchange side configured to receive the compressed gas exiting a first stage of the gas compressor and convey cooled compressed gas exiting the second heat exchanger to an inlet of a second stage of the gas compressor, and
ii) conduit to the second heat exchange side configured to receive gas exiting a first stage of the expander-generator and convey reheated gas exiting the second heat exchanger to an inlet of a second stage of the expander-generator.

4. A system according to claim 3 and further comprising a third heat exchanger having a first heat-exchange side and a second heat-exchange side and additionally having
a) conduit to the first heat exchange side configured to receive the compressed gas exiting the second stage of the gas compressor and convey cooled compressed gas exiting the third heat exchanger to an inlet of the first heat exchange side of the first heat exchanger, and
b) conduit to the second heat exchange side configured to receive the supercritical, liquid or gaseous fluid from the first heat exchanger and convey heated supercritical, liquid, or gaseous fluid to the expander-generator.

5. A system according to claim 4 wherein the conduit to convey the heated supercritical, liquid, or gaseous fluid to the expander-generator comprises conduit to an inlet of the first stage of the expander-generator.

6. A system according to claim 5 and further comprising a fourth heat exchanger having a first heat-exchange side and a second heat-exchange side and additionally having
a) conduit to the first heat exchange side configured to receive the cooled compressed gas exiting the third heat exchanger and convey further-cooled compressed gas to the inlet of the first heat exchange side of the first heat exchanger, and
b) conduit to the second heat exchange side configured to receive expanded gas discharged by the first stage of the expander-generator and convey reheated gas to the second heat exchange side of the second heat exchanger.

7. A system according to claim 6 and further comprising a fifth heat exchanger having a first heat-exchange side and a second heat-exchange side and additionally having
a) conduit to the first heat-exchange side configured to receive the liquefied gas in gaseous form from the second heat-exchange side of the first heat exchanger and convey further heated gas to the second heat-exchange side of the third heat exchanger, and
b) conduit to the second heat-exchange side configured to receive a heating fluid at approximately ambient temperature.

8. A system according to claim 7 and further comprising a sixth heat exchanger having a first heat-exchange side and a second heat-exchange side and additionally having
a) conduit to the first heat-exchange side configured to receive reheated gas from the second heat-exchange side of the fourth heat exchanger, and
b) conduit to the second heat-exchange side configured to receive a heating fluid at approximately ambient temperature.

9. A system according to claim 8 and further comprising a seventh heat exchanger having a first heat exchange side and a second heat exchange side and additionally having
a) conduit to the first heat exchange side configured to receive heated compressed gas from the second stage of the gas compressor and convey cooled compressed gas to an inlet of a third stage of the gas compressor, the third stage of the gas compressor additionally having conduit to convey heated compressed gas to the first side of the third heat exchanger; and
b) conduit to the second heat exchange side configured to
i) receive the expanded gas from one of (a) the discharge of the first expander-generator directly, (b) the second heat exchange side of the fourth heat exchanger, (c) the first heat exchange side of the sixth heat exchanger, or the second heat exchange side of the second heat exchanger to form additionally heated gas and
ii) convey the additionally heated gas to the second expander-generator.

10. A system according to claim 4 wherein the third heat exchanger's conduit to convey the heated supercritical, liquid or gaseous fluid to the expander-generator comprises conduit to an inlet of the second stage of the expander-generator.

11. A system according to claim 10 and further comprising
a) a third stage to the gas compressor having conduit to an inlet of the third stage, wherein the conduit receives the cooled compressed gas exiting the first heat exchange side of the third heat exchanger,
b) a fourth heat exchanger having a first heat exchange side and a second heat exchange side,
i) the first heat exchange side comprising conduit configured to receive compressed gas from a discharge of the third stage of the gas compressor,
ii) the second heat exchange side comprising conduit to receive the supercritical or liquid fluid from the second heat-exchange side of the first heat exchanger and convey heated supercritical or liquid fluid to the first stage of the expander-generator
c) a fifth heat exchanger having a first heat exchange side and a second heat exchange side,
i) the first heat exchange side comprising conduit configured to receive cooled compressed gas from the first side of the fourth heat exchanger and provide further-cooled compressed gas to the first heat-exchange side of the first heat exchanger, and
ii) the second heat exchange side comprising conduit configured to receive expanded gas from the first stage of the expander-generator and convey heated gas to the second heat-exchange side of the second heat exchanger.

12. A system according to claim 11 and further comprising a sixth heat exchanger having a first heat-exchange side and a second heat-exchange side, and additionally having
a) conduit to the first heat exchange side configured to receive heated gas from the second heat exchange side of the fifth heat exchanger and convey further-heated gas to the second heat exchange side of the second heat exchanger, and
b) conduit to the second heat exchange side configured to receive a heating fluid at approximately ambient temperature.

13. A system according to claim 12 and further comprising a seventh heat exchanger having a first heat-exchange side and a second heat-exchange side, and additionally having
a) conduit to the first heat exchange side configured to receive the heated supercritical or liquid fluid from the second heat exchange side of the first heat exchanger and convey further heated supercritical or liquid fluid to the second heat exchange side of the fourth heat exchanger, and
b) conduit to the second heat exchange side configured to receive a heating fluid at approximately ambient temperature.

14. A system according to claim 1 and further comprising an electrically-powered gas liquefier having conduit to receive compressed gas from a last stage of the gas compressor and to convey liquefied gas to the storage vessel.

15. A system according to claim 1 wherein the gas is air and the inlet to the gas compressor and the outlet from the expander-generator are each open to atmosphere.

16. A system according to claim 7 wherein the second heat exchange side of the fifth and/or sixth heat exchangers is configured to convey ambient air as the heat exchange medium.

17. A system according to claim 9 wherein the second heat exchange side of the seventh heat exchangers is configured to convey ambient air as the heat exchange medium.

18. A system according to claim 1 wherein the system is a stand-alone system that is not connected to a cryogenic air processing system that separates gas components from air.

19. A system according to claim 1 wherein the fluid discharged from the second heat exchange side of the first heat exchanger comprises a supercritical fluid.

20. A system according to claim 1 wherein the fluid discharged from the second heat exchange side of the first heat exchanger comprises a gas.
